(19) United States
(12) Patent Application Publication
(10) Pub. No.: US 2020/0320644 A1
(43) Pub. Date: Oct. 8, 2020

(54) SYSTEMS AND METHODS FOR AUTONOMOUS BRANDING USING A PLATFORM THAT CONTAINS A PLURALITY OF FEATURES AND FUNCTIONS THAT ENABLE ANY USER TO HAVE ACCESS TO A COMPLETE DIGITAL PRESENCE AND MONETIZATION OPPORTUNITIES

(71) Applicant: RICHARD B HOLLIS, SAN DIEGO, CA (US)

(72) Inventor: RICHARD B HOLLIS, SAN DIEGO, CA (US)

(21) Appl. No.: 16/374,721

(22) Filed: Apr. 3, 2019

(51) Int. Cl. G06Q 50/00; G06Q 30/02; G06N 3/02

(52) U.S. Cl. CPC G06Q 50/01; G06N 3/02; G06Q 30/0258; G06Q 30/0222

(57) ABSTRACT

Disclosed herein is a system and method optimizing and monetizing social media presence. The present invention further contemplates an artificial method for managing social media activity. In some aspects, the system and method may be implemented by software designed for users such as, for example, small businesses, to manage and implement an online digital strategy. A digital web-based platform, for example, may be used to establish and expand the online presence of a brand. In some aspects, the systems and methods may be implemented to publish, syndicate, and monetize content in an automated and seamless manner from a single interface as well as to monitor and respond to information relevant to such content.

### BACKGROUND

This present invention discloses a network connected platform for the purpose of monetizing an individuals' brand identity. The platform seeks to solve problems with existing methodologies by autonomously building and monetizing social media presence and digital assets. Previously, a platform that autonomously supported an individual brand while connecting influencers across social media spaces has not existed. In particular, the present invention seeks to disclose a network that realistically provides an average user the opportunity to monetize their social media presence, take steps to improve their presence, while controlling the disclosure of information to the public. The network's primary objective is to promote and aid the entrepreneurial spirit. The network further aggregates, captures, and interacts with data across multiple social media platforms and generates a new unique space, known as a “Holospace” for the purpose of building a cross functional brand identity.

### SUMMARY OF THE INVENTION

Within the last decade, social media has established itself as a universal medium for communication, advertising, and self-promotion. As of 2017, 1 in 3 people in the world use some form of social media. The constant availability for the average person to be “connected” to others has caused an influx of social media platforms in the recent years. However, none the platforms have allowed the average user to monetize their own digital assets and social media presence, or build their own brand identity.

In addition, the majority of platforms even go so far as to utilize a user's personal information to their own benefit. Targeted ads and audiences are made up of a user's information disclosed on a platform, that cost advertisers significant money, and do not benefit the provider of the information. In short, current methodologies fail to incorporate the average user in the monetization process, even where it exists.

It is clear however, that social media presents an avenue for potential monetization of an individual's personal brand. Persons with specific and large outreaches, or Influences, can monetize their social media presence by joining with advertisers looking to promote their goods and services. However, the methodology by which an average user builds their social media presence and monetizes that presence leaves much to be desired. In particular, the individuals most likely to capitalize on their social media presence tend to be either: 1) famous persons who are already have significant influence in non social-media settings, or 2) “viral” sensations that luck into influence, often without intending to do so. The average user does not have adequate tools to build a monetizable social media presence.

Additional issues surrounding the current methodology relate to the manner in which advertisers connect with influencers. There are almost methods which an influencer and advertiser are paired. Thus, the existing influencer marketplaces tend to connect the most powerful influencers with advertisers without consideration regarding optimization. Advertising with such influencers tends to be expensive and without guarantee of result. There is a clear void with respect to monetizing the presence of influencers with a modest followings or targeted audiences.

In addition, self-promotion is a primary benefit of social platforms. However, currently existing social media platforms are typically singular, and do not allow for a way to interact across platforms to build brand identity. However, the work needed to monetize one's presence across platforms is significant and out of reach of the average user. Thus, even if an average user begins to build some level of influence on one platform, they are often stifled by their lack of presence on another platform. Moreover, there is no viable method for the average user to easily build their monetization power across multiple platforms organically and simultaneously.

The present invention seeks to optimize social media presence by improving brand identity across multiple platforms. It further seeks to provide an outlet for all users to advertise and connect with advertisers based on their influence. In particular, by rewarding self-promotion, the present invention provides an avenue for the average user to quickly monetize their online presence. Moreover, the platform provides a user the ability to build that presence across multiple outlets simultaneously.

The portal allows a user to create an account and offer services to other users for fixed prices (or undertake an offer if they are accepting of the compensation). This portal allows a user to use their personal talents as a means for making money while also making it easier for patrons to find people who may offer services that they require.

A major hurdle associated with improving brand identity over several platforms relates to information security. Currently, the existing platforms do not provide a method to secure or control disclosure of one's data and information. As a result, Social Media platforms have come under attack from hackers and negative actors. One method of securing background communications on social media is through a secure ledger blockchain network.

Through the use blockchain technology, the present invention seeks to disclose a secure ledger decentralized platform that provides a cost effective and improved method of secure social media transactions.

Blockchain technology (sometimes simply referred to as a blockchain) was developed and has been used in certain digital currency implementations. An example implementation and corresponding blockchain techniques are described in a 2008 article by Satoshi Nakamoto, called “Bitcoin: A Peer-to-Peer Electronic Cash System,” the entire contents of which are hereby incorporated by reference. With that being said, in certain embodiments discussed herein, the blockchain may be privately hosted (e.g., where all member nodes are run and provided by the same entity or a controlled group of entities). In certain example embodiments, the blockchain may be a distributed blockchain, such as the one provided by the bitcoin network. Thus, the term blockchain as used herein is not confined to the so-called blockchain that is only used for the bitcoin cryptographic currency.

The blockchain is a data structure that stores a list of transactions and can be thought of as a distributed electronic ledger that records transactions between source identifier(s) and destination identifier(s). Every transaction is “to” a destination identifier that is associated with a public/private key pair. In creating a new transaction, outputs from other, prior transactions that are to the “from” address (which may be multiple different addresses derived from the same private key) are used as inputs for this new transaction. The new transaction is then encumbered with the public key associated with the “to” destination identifier. In other words, outputs from prior blockchain transactions are used as inputs for new transactions that are then signed using the public key associated with the destination address. The new blockchain transaction is then submitted to the blockchain.

Once on the blockchain multiple such transactions are bundled into a block and the block is linked to a prior block in the “blockchain.” Computer nodes of the distributed system then maintain the blockchain and validate each new block (along with the transactions contained in the corresponding block). The techniques described herein make use of blockchain technology to address one or more problems with the conventional database systems

Blockchain technology holds great promise for a range of industries and business cases, including the patent asset class. That is because a Blockchain can be viewed as a type of shared database, the contents of which are verified and agreed upon by a network or independent actors. For a new piece of data (such as the owner of a newly issued patent) to be added to the Blockchain, the independent verifiers must come to consensus on its validity.

Because each new set of transactions (a “block”) is cryptographically linked to the previous block, it is extraordinarily difficult to change data stored in a Blockchain and any such change would be readily detectable. Thus, blockchains are widely considered to be immutable and thus can serve as a record of proof of ownership.

When transacting in a Blockchain platform, each user makes use of a public address (needed for other actors in the network to send a transaction to that user), and a cryptographically paired “private key.” Private keys are used to sign transactions digitally, a form authentication to ensure that a given user has genuinely generated a transaction.

Blockchain is a relatively new technology. The first “real world” implementations of Blockchain, Bitcoin, envisioned by Satoshi Nakamoto launched in 2009. The Ethereum Blockchain was released in 2015. In addition to the distributed ledger capability of the Bitcoin Blockchain, the Ethereum Blockchain allows so-called “smart contracts,” which are programs stored in the Ethereum Blockchain that can act autonomously to execute sophisticated transactions.

Blockchain data transfer is currently considered one the most secure technologies for digital asset transfer due to its distributed nature and use of sophisticated cryptography. Smart contracts, therefore, offer a potential solution for the management of patent transactions via the introduction of a universal, distributed ledger that does not require trust in a single third party.

The Bitcoin blockchain is limited to sets of simple information and scripts such as transaction details, and conditioning a transaction on a minimum number of signatories. It was therefore argued that for a virtual currency to truly revolutionize trade it must also provide built-in means for facilitating complex contracts and deals with the currency.

Project Ethereum builds upon Bitcoin. Not only does it allow decentralized data storage in its blockchain, Ethereum also allows storing program code on its blockchain and running it concurrently by any number of network members. By predicating release of funds upon verifiable occurrences, Ethereum enables smart contract functionality.

Basically, a network member uploads a computer program written in one of several permitted languages to the blockchain. The member may then condition the release of an amount of ETH (the currency underlying Ethereum) upon reaching the end of this program. Various network members thereafter run the program concurrently and reach a consensus on the resulted output.

The scripting languages in Ethereum or the IBM Hyperledger are Turing complete as they can implement any logic rules and initiate any calculations available.

This feature allows any member to issue and trade with a custom virtual currency upon the Ethereum network. For the sake of clarity, a custom virtual currency issued and based upon another virtual currency is referred to as a Token. A Token may have various uses. While a certain Token will represent money, another Token will represent club member points or frequent flyer points. Tokens may be traded for ETH or for any other commodities and Tokens via the Ethereum or the IBM Hyperledger network.

Before Ethereum or the IBM Hyperledger, a person was required to launch a new blockchain utilizing custom user clients and mining algorithm, in order to issue a custom decentralized virtual currency. The emergence of the Ethereum or the IBM Hyperledger network allows easy issuance of Tokens with minimal setup.

It should be mentioned that after Ethereum, several other virtual currency networks implementing smart contracts were established. Prominent examples include the IBM Hyperledger, Lisk and RootStock.

These are just a few ways that the invention has implemented their belief of monetization of services. The inventors believe that entrepreneurism has dwindled in recent years and they strive to expose the millennial population to the idea of capitalizing on their abilities. The invention “combines everything needed to build a personal brand and utilize it to make money or achieve a personal goal into one space”.

The inventor's mission statement is that “anyone with ideas, skills, talents, passions and the hustle to make it happen can be an entrepreneur. The invention was created to empower all individuals, businesses and organizations with the ability to thrive in today's digital economy.” As the world changes in how people make money, it is important for more and more modes of capitalizing to sprout. The invention is the first of its kind to operate as a platform designed and intended to function as a medium for capitalism. In order to build a brand, one must have the tools and the support to do so. The invention provides all of the essentials and more in order to take the spirit of entrepreneurship to the next level.

Another important aspect of this invention relates to artificial intelligence in the promotion of an average user's brand identity. Specifically, the existing platform envisions an autonomous engine that recursively optimizes the actions a user can take across multiple platforms to increase their social media presence and thus their ability to monetize their individual brand. By reviewing a user's network, habits, and potential, an artificial network deployed on a blockchain can securely aid in the autonomous improvement of one's online presence, thus allowing for greater potential with less effort.

These and other features, embodiments, and aspects of the present invention can be appreciated from the following drawing description and detailed description of the preferred embodiment.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any invention described herein.

### BRIEF DESCRIPTION OF THE DRAWINGS

FIG. 1 is flow diagram of one present embodiment.

FIG. 2 is a system diagram of one embodiment of the network.

FIG. 3 is a system diagram depicting one embodiment of the present invention.

FIG. 4 is a network diagram showing a blockchain network as contemplated in the present invention.

FIG. 5 is a diagram of the advertising monetization system of the present invention.

FIG. 6 is a diagram of the overall advertising monetization method of the present invention.

FIG. 7 is a diagram of the advertising monetization page creation method of the present invention.

FIG. 8 is a diagram of the advertising monetization ad placement method of the present invention.

FIG. 9 is a diagram of the buyer offer method of the present invention.

FIG. 10 is a diagram of the buyer offer method of the present invention.

FIG. 11 is a diagram of the offer cancellation process of the present invention.

FIG. 12 is a diagram of the offer fulfillment process of the present invention.

FIG. 13 is an overview of the combinatorial ecosystem of the present invention.

FIG. 14 is an overview diagram of the combinatorial ecosystem platform of the present invention.

### DETAILED DESCRIPTION OF THE PREFERRED EMBODIMENT

The proposed invention discloses a platform for monetizing social media presence. It can be deployed on both a traditional centralized network or a secure ledger, or blockhcain network. In addition, the present invention may use data analytics to implement a system that can provide a customized and artificially intelligent optimizations. Such optimizations can result in cross platform improvements that seek to improve the reach, influence, presence, of the average social media user across multiple outlets. In addition, the same optimizations may result in the increased ability of the average user to monetize their individual brand and social media presence.

The advent of the internet has brought forth various ways for individuals, businesses, and entities to connect on a global level. Such are often based on centralized platforms that allows for interaction amongst various subscribers. However, these social media outlets often fail to empower average users with the tools needed to monetize their presence.

Specifically, current social media networks present several avenues where the platform owner, rather than the subscriber can profit from the user's presence: 1) The collection and sale of user data; 2) forced and targeted advertising services to users based on their data; and 3) an advantage in understanding the popularity of certain business models and services due to their mass collection of private data. In the rare instances where average users can monetize their presence, the social media platforms do not provide a globalized method of transactions. The present invention seeks to provide a more efficient system and method to empower all user to easily manage various platforms, and monetize their online presence on a global scale. It further provides a marketplace where any user can connect with advertisers or other users and take advantage of their audience. The platform envisions a method of directly rewarding users for their social media activity.

In some embodiments, the systems and methods disclosed herein can be implemented by hardware and software designed for average users or businesses. Businesses, for example, may manage and implement their online digital strategy based on the availability of specific and moderate influencers. Additionally, in some embodiments, the platform allows users to easily build a web-based storefront to establish and expand their brand's online presence.

Various systems and methods disclosed herein can be implemented by users to publish, syndicate, and monetize their social media presence as well as to monitor and respond to information relevant to their success. The platform as implemented with the hardware and software as described herein provides significant advantages to businesses over other platforms such as Facebook and Linkedln or various other platforms for enhancing and managing their electronic interactions with other businesses and consumers.

Some embodiments comprise a software framework having a modular architecture. Modules can comprise independent software applications and/or processes that can deliver relevant and customizable feature sets to different users. For example, modules can be business specific with the goal of attracting and/or retaining customers.

In some embodiments the systems interact with or adopt at least one social media component. Social media components may include, for example, Twitter, Facebook, YouTube, Snap Chat, or any other online social platform. Modular components and/or applications can combine multiple types of content (including social media content), create content (including social media content), and publish the content within a specific section of a larger software or web-based platform.

The system can include a platform comprising “digital spaces.” A “digital space,” or “Holospace” is a combination of computer memory and computer processor instructions that are configured to store content created by a given platform subscriber, display some or all of the stored content to visitors of the platform in response to visitor search queries, push some or all of the stored content and/or links to some or all of the stored content to servers and storage locations on the internet different from the memory associated with the digital space, and present to the platform subscriber a user interface (sometimes referred to as a dashboard herein) allowing the subscriber to control some or all of the above described functionality. As such, each digital space can be accessed by at least one subscriber. In some embodiments, subscribers can create content and publish the content in selected media categories. In response to this publication, the system can automatically generate a unique RSS feed for each media category that the users publish into. Distribution services can extend each feed type as an outbound marketing tool into local RSS search engines, popular readers and/or other websites.

In another embodiment, a user's digital space may also include the ability to interact with an integrated marketing center. The application can be displayed in a user's digital space. The marketing center can utilize content and media creation assets and suggest a marketing approach specific to the user. Processes can monitor specific interactions with consumers, geographic and industry category trends, historical decisions and trends, and third-party input. The system can then suggest insights and standardization for distribution across social channels, paid search channels, banner, and localized GEO Mobile interactions.

In some embodiments, a user's digital space can include systems and processes that can track and discover factors which affect SEO rank positions for keyword searches by end-users. The methods can abstract from current web crawler approaches by compiling data from standard sources, social sources, media sources, communication sources, syndication and user oriented re-syndication action sources, and use proprietary mathematical models for distilling this data into easily recognizable actions triggered by content and media creation. The system can provide suggestions to the user and or display the results in the user's digital space.

Some embodiments include systems and methods for end-users or consumers to join and interact with any platform or technology developed by the user. For example, the systems can archive and track the media content and historical references for the life of the user. Users that are given access to the platform can engage in one-to-one direct communication with other user accounts on the platform. The system can collect specific data on consumer and/or user behavior, product choices, communication sequences, conversation modeling, and many other mathematical factors. This user and/or consumer data can be embedded into enterprise analytics products.

In some embodiments, a user's digital space can include systems and processes constructed from an Abstract Factory Pattern to recreate the directory, experience, and media assets of the user's business on the platform into a social network fan or account page. The systems and methods can include managing complex API integrations with existing and emerging social networks and carrying third-party integrations from one platform to another to provide the user's business with value in consuming products that previously did not operate well cross-platform.

In some embodiments, a digital space can be launched for any social media business or large-scale entity wanting to empower sales or marketing teams with dedicated publishing spaces for direct one-to-one interaction with consumers. This single “push” management offers highly scalable opportunities to manage huge networks like hosted datacenters. Digital spaces can be linked and information can be shared and tracked in order to monitor to development, growth, new product releases, and/or enhancements offered by related users.

A digital space may also include a virtual storefront. The storefront may enable a business to efficiently manage their advertising, branding, and online presence. The software modules may include a standard set of pre-bundled dynamic displays that users can interact with. In some embodiments, subscribers can customize the digital space and/or storefront through an interface accessible to subscribers.

The interface may include a dashboard. The dashboard may comprise one or more software modules that include interactive displays. The dashboard may allow a subscriber to edit the digital space. For example, dashboard may allow for a subscriber to reposition elements, change design choices, and manage their digital space. In some embodiments, a subscriber's dashboard includes applications and features designed to order information, generate communication and archive resources, products, and/or services from the platforms that the digital space interacts with and/or from the web in general. In some embodiments, the dashboard mimics a mobile desktop environment.

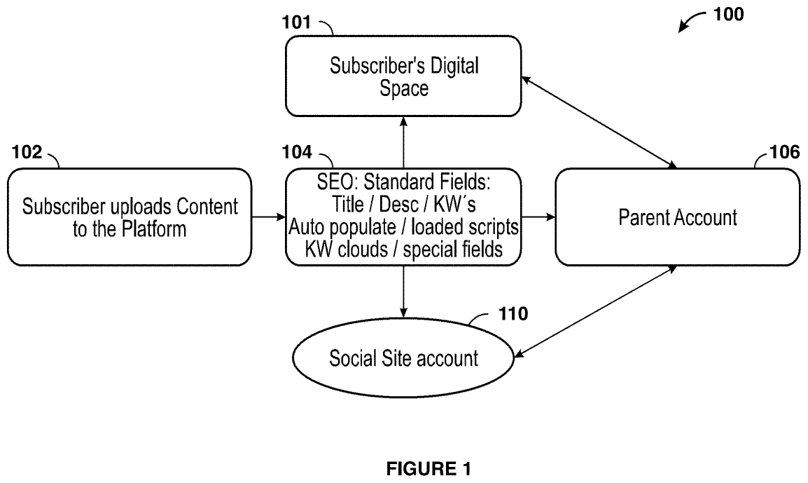

Turning to FIG. 1, a block diagram of a system and method of distributing content 100 is illustrated. A subscriber's digital space 101 may include a plurality of webpages. New webpages on the digital space 101 may be created when a subscriber uploads content to the platform 102. The uploaded content 102 may be search engine optimized in at least a partially automated manner 104. In some embodiments, the search engine optimization 404 includes prompting a subscriber for additional information about the uploaded content, labeling the content with a title, description, and keywords, and/or providing meta tags. Uploaded content that is SEO optimized may then be published on the digital space 101 and the subscriber's social media website account(s) 110 automatically. In some embodiments, a parent account 406 may be linked to the digital space 101 and the social media website account(s) 110.

In some embodiments, a subscriber may be required to receive prior approval of content that is displayed in the subscriber's digital space and/or syndicated through the subscriber's channels. One or more software modules may be configured to fully or partially provide for review the content for key words or obscene content. This functionality may be referred to as a compliance engine. In some embodiments, content approval may be provided by the subscriber's parent account or company. For example, in some industries, a subscriber may be an independent contractor or agent affiliated with an organization. The organization may require that all content published to the internet be pre-approve or compliant with the organization's standards and/or advertising campaign and/or brand message. Thus, in some embodiments, content that a subscriber wishes to display on their digital site and/or syndicate must first be sent to the subscriber's organization or parent account. If the subscriber's organization or parent account approves the content, then the content may be published and/or syndicated. If the content is not approved, the content may be returned to the subscriber.

In some embodiments, the platform can include systems and methods that can extract keyword relevancy at the semantic and natural language level. The methods of collection can focus on internal interaction of the platform or any deployed platform anywhere on the web, accesses content spiders which crawl the web, and/or accesses Google's index and/or Facebook's Social Graph. The process can compile massive contextual information into an intuitive interface that offers full sentence related suggestions that are highly relevant, while the business is in the process of creation.

In some embodiments, systems disclosed herein are configured to capture, tag, play, and edit video content uploaded to the platform One or more software modules may be configured to upload a single piece of video content into a unique dedicated page structure that is optimized for full search engine visibility, sharing, conversion, and broadcasting to participating channels and/or social accounts. Subscribers may create unlimited unique pages, with each page acting as a unique entry point into the subscriber's digital space. Each page can also function as a page for generating and responding to comments from customers, answering questions, and creating deeper engagement with the public through streamlined central messaging.

Editing of uploaded video may be accomplished with one or more software modules configured to, for example, trim, stabilize, insert transitions, annotate, and/or add music or text to the video. Uploaded video may be edited immediately after upload or at a later time. Fields to capture meta information can be supplied to the subscriber before finalizing the public availability of the content. Subsystems such as predicative keyword and tagging insertion, help annotations, and links for industry, geographic location, and category.

In some embodiments, meta tagging is supplied by an intelligently learning keyword driven database that measures one or more factors of the upload and suggests anything from a single word to full sentences recognized as potentially optimized for that particular businesses location, industry, categories, and products. Video may be uploaded from a storage system or captured live from, for example, a webcam in addition, mobile browsers may initiate the same action through, for example, an HTML 5 enabled interface. In some embodiments, video may be uploaded directly from a mobile device.

In some embodiments, the platform can include systems and methods that can collect object-to-action-to-communication-to-conversion metrics for all behavior of consumers and businesses across the web and across any social business platform. The information can be compiled into complex 4th dimensional database systems. A method can then supply analytic measurements and insightful degrees of separation for social interaction, and/or global economic views.

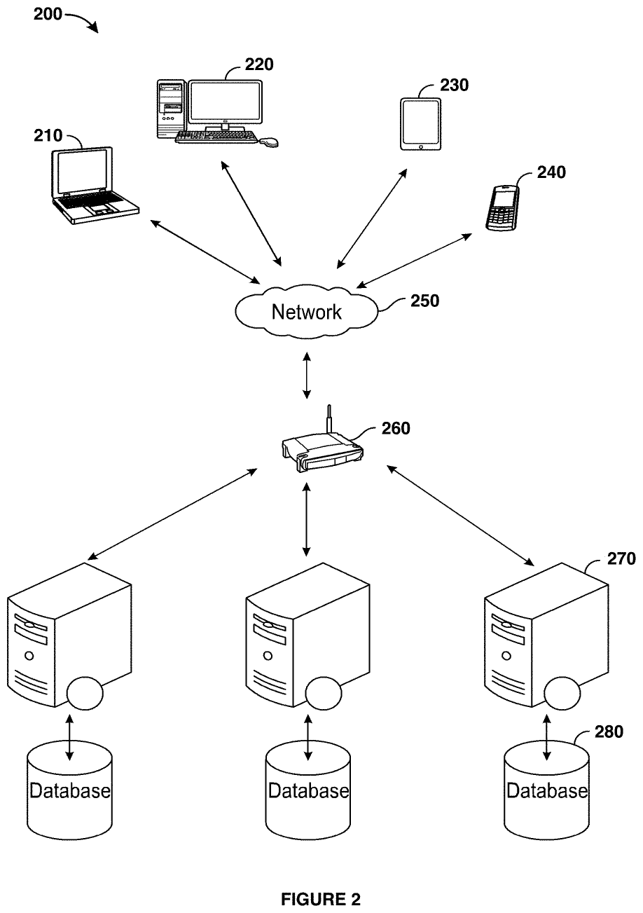

Referring to FIG. 2, a block diagram is illustrated of a network employing a method and system according to the invention. It is anticipated that the present web application system 200 operates with a plurality of computers which are coupled together on a network, such as the Internet 250, or other communications network. FIG. 2 depicts a network that includes user computers 210, 220, 230, and 240 that communicate with one or more web servers 270 though communication links that include the Internet 250. The user computers 210, 220, 230, and 240 may be any type of computing device that allows a user to interactively browse web sites, such as a personal computer (PC) that includes a web browser (e.g., Microsoft Internet Explorer™ or Google Chrome™). Suitable user computers equipped with browsers are available in many configurations, including handheld devices 140 (e.g., Apple iPhone™, Google Android, or RIM Blackberry), personal computers (PC), laptop computers 210, workstations 220, television set-top devices, tablets (230) and so forth.

The one or more web servers 270 may be optionally managed by a load balancer 260. Load balancer 260 may receive requests from computer network 250 and route these requests to one or more web servers 270 based on a variety of criteria. These criteria may optionally include the current load of each web server 270, session information included in the network request, a round robin counter maintained by load balancer 260, or other criteria.

One or more web servers may also communicate with one or more databases 280. These databases may be in a mirrored or striped configuration to support the data storage requirements of web applications running on web server(s) 270.

The web server(s) 270 includes a server computer running a web interface application and capable of selectively delivering data files, such as HTML files, to the user computers using a protocol such as HTTP. Web server 270 may also dynamically generate content for delivery to user computers in response to a request from a user computer. The content may be generated by web server 270 directly, or may be generated by other computers linked to web server 270 in response to a request from web server 270. Web server 270 may then forward the requested content to a user computer over network 250.

In some embodiments, systems disclosed herein are configured to allow subscribers subscriber to create, publish, manage, and syndicate their products and/or services. The subscriber can create unlimited deals of any type and embed a preexisting ad creative (e.g., previously printed ad in newspaper or magazine), a single photo, or a video to give the offering more depth and information. Each deal created and managed by the subscriber can receive a unique, dedicated search visible page whereby users can access specific information on the business, on the deal, the redemption process, fine print disclosures, reviews, and locations. In some embodiments, each user or registered user that accesses a deal for consumption receives a voucher by email. In addition, information regarding users who accesses a deal may be provided to the subscriber.

Deals may be deleted, edited, changed, or de-listed at any time. The subscriber may be able to re-activate archived deals and thus a subscriber may have running inventory of deals that can be activated or de-activated in response to product overstocking, deeply discounted manufacturer incentives, seasonality, holidays, and many other categories which affect the type and nature of the offering to the public without recreating them Each newly created deal may be syndicated as desired. In some embodiments, archived or re-activated deals are not re-syndicated unless the subscriber wishes to push that information out to their respective networks. Registered users may capture deals and store them inside of their dashboard, referencing them immediately or at a later time through interior communication directly with the subscriber. In some embodiments, the system is configured to inventory all active deals on either a bi-weekly or monthly basis and blast deals to registered users that have pre-selected or filtered their deal preferences by product, service, and/or geography. The blast may comprise email sent to registered users and may include expiring deals and the new or popular deals in their area.

In some embodiments, a subscriber's digital space may include at least one page for the sale of products and/or offer for services. Such pages may have the same unique and dedicated search optimized structure as other media pages within the digital space, but with the distinction of being focused towards creating exposure and distribution for products and/or services. The platform may include an ecommerce based system. As described in further detail below, such an ecommerce system may include a Payment Card Industry (“PCI”) compliant methodology, or a cryptocurrency methodology for global transactions. Thus, in some embodiments, one or more pages of subscriber's digital space are configured to accept and process payments from users. In some embodiments, a user's digital space may interact with third party web site APis to provide an e-commerce APP to the subscriber ecommerce and/or virtual storefront pages. In some embodiments, the platform may include one or more software modules configured to syndicate product related content to social networks and ecommerce platforms such as Amazon, eBay, Etsy, Googlebase and others. The subscriber may be able to manage the experience, inventory, design, marketing, transactions, financial processing, shipping fulfillment, customer management, and more in an integrated manner that may be displayed in the subscriber's dashboard. In addition, the platform may capture, measure, and store metric and meta information relating to all sales the transactions, products, customers, sales and customer locations, previous purchases, pricing, demographics and other areas. Such information may be sorted, displayed, and analyzed using the subscriber's dashboard and/or displayed on a dedicated page on the subscriber's digital space.

In some embodiments, the platform is configured to enable subscribers to create, edit, manage, launch, measure, and/or processing a marketing campaign that interacts with social media, SEO, PPC, ad networks, gamification, drip email, and any other channels available to the subscriber. Such a marketing tool may be available on the subscriber's dashboard. The marketing tool may allow for the subscriber to tailor a marketing campaign by selecting uploaded content to be syndicated, selecting the time and date the content will be syndicated, and selecting the channels that the content is syndicated to. One or more modules may then distribute the selected content according to the subscriber's input. In some embodiments, a subscriber's database of uploaded content may be searched and navigated with a script driven framework that floats within the interface. A subscriber may then select content generated by that search for insertion into any campaign or campaign template. Thus, in some embodiments, a module accessible through a subscriber's dashboard is configured to organize, automate, and synchronize a subscriber's marketing campaign and is included within the platform. In some embodiments, one or more software modules can be configured to extract product information from a subscriber's pre-existing ecommerce pages or information. This module may then replicate this information on unique pages on the subscriber's digital space and/or throughout other social networks enabling multiple purchasing options for users.

In some embodiments, the platform is configured to store data regarding a user's social media uses in a digital database. This network itself can be configured to review the patterns of any number of users and mimic the same. The network can engage and interact with multiple social media services simultaneously. In another embodiment, the network can use historical data of successful business operations to launch similar strategy on digital spaces. The network itself can make recommendations for changes in advertisement strategies, SEO strategies, and engagement levels. The ability to seamlessly and transparently auto-post content, media, deals, advertisements, general notifications, and other elements to the subscriber's social media channels is limitless. Through a variety of integration methods, for example, partnership deals or general API connectivity, the platform may also be configured to update business listing information across local search properties, participating directories, and other channels. While a dashboard and/or admin-interaction page may contain controls for limited customization aspects, the platform may autonomously use successful campaigns to syndicate on multiple platforms. In some aspects, content provided by a subscriber to their digital space can syndicate to the subscriber's social channels in a fully automated or partially automated manner. In some embodiments, the platform is configured to accept and push varying data communication protocols such as, for example, gets, http post requests, batch uploading, and general XML integration.

In some embodiments, media content is received from a subscriber. The subscriber may for add, edit, or delete the received content. The content may then be autonomously syndicated to one or more of the subscriber's social and/or other third-party media accounts. For example, the systems described herein allow for a subscriber to upload a video, edit the video, and syndicate the video to registered accounts for Limelight, YouTube, or any other registered video streams. In another example, subscribers may upload a message, deal, or other E-commerce product to selected social channels from the subscriber's list of registered social channels. The channels may be displayed in the subscriber's dashboard. Subscribers may also view all posts, messages, and/or articles that are syndicated to different social media channels and their respective analytics.

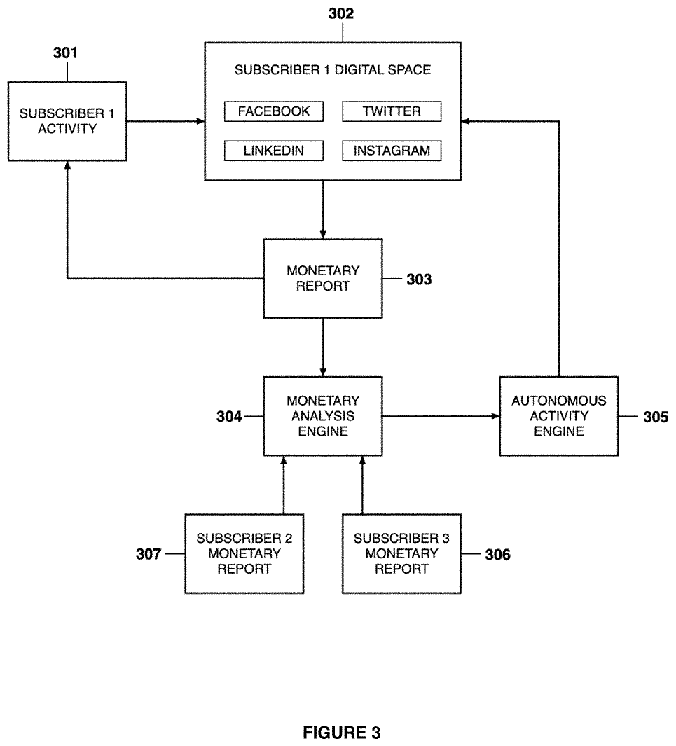

FIG. 3, represented by the numeral 301, depicts one embodiment of the present invention. A subscriber 1 conducts social media activity 301 using their digital space 302. The correlation between the activity and monetary value is provided in a monetary report 303. A monetary analysis engine determines the specific actions 304 that resulted in monetary value, and presents a task list to the autonomous activity engine 305. The autonomous engine 305 further conducts activity on behalf of subscriber one on the digital space 302. In addition, monetary reports from various subscribers such as subscriber 2 depicted as numeral 307, and subscriber 3, depicted as numeral 306 are also provided to the monetary analysis engine so that it can use historical data from various users to improve the monetization of subscriber 1.

In another embodiment, the current platform allows a subscriber to monetize various aspects of their own online presence, including through offering services, and agreeing to provide data in exchange for targeted advertisements. Moreover, the network may be configured to collect data, and inform users of the value of said data to certain advertisers and publishers.

Another embodiment of the present invention seeks to connect subscribers and allow transactions on the platform using a decentralized network. The decentralized network provides several benefits including the ability to transact with virtual tokens, or cryptocurrency, the ability to deploy smart contracts, and the ability to provide additional security for data. This decentralized network will require at least one server, a processor, and at least one networking interface (“Network”). Such a Network will allow the connection of user devices through the Internet. The Network itself will consist of at least one server, which will host a webpage, that when executed, will allow users to access a portal and be identified cryptographically using a private key and public key. The web portal or other network connected device will provide a platform to connect a patent owner with other stakeholders in the patent process.

In one embodiment of the present invention, the decentralized network is a blockchain network. Blockchain technology (sometimes simply referred to as a blockchain) was developed and has been used in certain digital currency implementations. An example implementation and corresponding blockchain techniques are described in a 2008 article by Satoshi Nakamoto, called “Bitcoin: A Peer-to-Peer Electronic Cash System,” the entire contents of which are hereby incorporated by reference. With that being said, in certain embodiments discussed herein, the blockchain may be privately hosted (e.g., where all member nodes are run and provided by the same entity or a controlled group of entities). In certain example embodiments, the blockchain may be a distributed blockchain, such as the one provided by the bitcoin network. Thus, the term blockchain as used herein is not confined to the so-called blockchain that is only used for the bitcoin cryptographic currency.

The blockchain is a data structure that stores a list of transactions and can be thought of as a distributed electronic ledger that records transactions between source identifier(s) and destination identifier(s). Every transaction is “to” a destination identifier that is associated with a public/private key pair. In creating a new transaction, outputs from other, prior transactions that are to the “from” address (which may be multiple different addresses derived from the same private key) are used as inputs for this new transaction. The new transaction is then encumbered with the public key associated with the “to” destination identifier. In other words, outputs from prior blockchain transactions are used as inputs for new transactions that are then signed using the public key associated with the destination address. The new blockchain transaction is then submitted to the blockchain. Once on the blockchain multiple such transactions are bundled into a block and the block is linked to a prior block in the “blockchain.” Computer nodes of the distributed system then maintain the blockchain and validate each new block (along with the transactions contained in the corresponding block). The techniques described herein make use of blockchain technology to address one or more problems with the conventional database systems to provide a pooled resource for influencers.

A computer, network, or blockchain, may deploy a smart contract. A smart contract is computer code that implements transactions of a contract. The computer code may be executed in a secure platform (e.g., an Ethereum platform, IBM Hyperledger platform) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes initializing the smart contract and its state. The state of a smart contract is stored persistently in the blockchain (e.g., via a Merkle tree). When a transaction is recorded against a smart contract, a message is sent to the smart contract and the computer code of the smart contract executes to implement the transaction (e.g., debit a certain amount from the balance of an account, transfer the ownership of a patent). The computer processes the code and ensures that all the terms of the contract are complied with before the transaction is recorded in the blockchain. For example, a smart contract may request an exchange of one type of cryptocurrency token to another. The computer executes code to determine the exchange rate and transfers the correct number of tokens to and from the correct accounts.

The blockchain network may include multiple computers, networks, links, and databases. Miners may manage the blockchain, whereas the managing may include, for example, validating a smart contract and/or transaction according to the smart contract, updating the blockchain with a validated smart contract and update the blockchain with a transaction that is executed according to the smart contract, determine that a suggested smart contract is invalid, determine that a transaction is not according to a smart contract, and the like.

In some embodiments, a smart contract may be accompanied by a digital certificate, or a digital signature which contains information regarding the source of the transaction. The computer, network, or blockchain will validate this information and determine the authenticity of the source of the transaction prior to deploying the smart contract.

The smart contract may determine the rules for transferring virtual currency based on the occurrence of some event, and any other rules that should be applied during a transaction.

The platform itself can construct a smart contract in real time based on inputs from a service provider and a user. In one embodiment, a user requests a service provider to provide various tasks such as a like on a birthday, or a comment on someone else's page. A smart contract containing the terms of the agreement is launched on the platform is autonomously deployed upon the occurrence of the proper events.

Finally, the blockchain network can be deployed using a private ledger. As such, any data can be protected from attack using a plurality of databases. Should the ledger fail to resolve, the system can detect a breach.

The blockchain typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person), and blocks are created by users known as “miners” who use specialized software/equipment to create blocks. In some embodiments, the block chain system disclosed, SS the number of miners in the current system are known and the system comprises primary sponsors that generate and create the new blocks of the system. As such, any block may be worked on by a primary sponsor. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases, that meets other criteria.

In one embodiment, the Network is made up of a plurality of nodes, each node connected to another node in the plurality of nodes, having the ability to pass data to each of the connected plurality of nodes. At least one node of the plurality of nodes is connected to an existing blockchain. Using this existing blockchain, the decentralized transactions can take place.

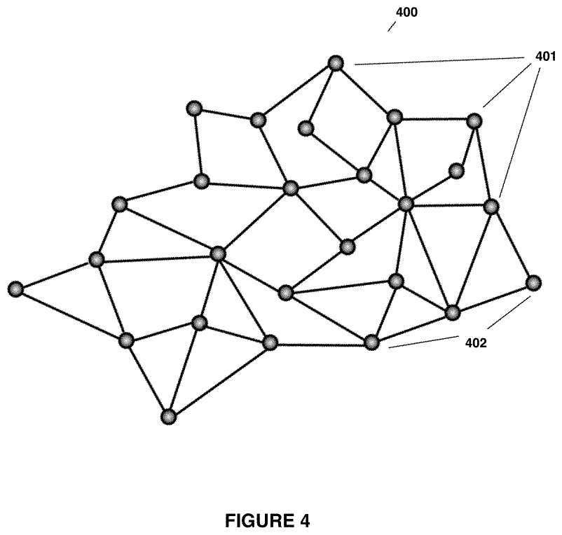

FIG. 4 depicts one aspect of the present invention. Specifically, the illustration shows the interconnection of each node 401 in a distributed decentralized network 400. In accordance with the preferred embodiment of the present invention, each node 401 in the distributed network 400 is directly connected to at least two other nodes 402. This allows each node 401 to transact with at least one other node 401 in the network.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provide services comprising receiving client update information from client devices, and responding to client lookup requests from client devices. The plurality of registry servers in each of the plurality of registry groups provide the services using a quorum consensus protocol.

As another example, a method is provided for device discovery and communication using a distributed hierarchical registry. The method comprises Broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

As another example, a computer-readable medium comprising computer executable instructions for causing a client device to perform a method for device discovery and communication is provided, the method comprising broadcasting a request to identify a registry server, receiving a response from a registry server, and sending client update information to the registry server. The registry server is part of a registry group of the distributed hierarchical registry, where the registry group comprises a plurality of registry servers. The registry server updates other registry servers of the registry group with the client update information using a quorum consensus protocol.

In some embodiments, the system is further able to conserve network and computing resources by securely storing information associated with user data, preventing potential malicious activity involving such information, conserving bandwidth, memory, and computation resources.

A digital wallet is software and hardware (or specifically designed hardware) that allows an individual to make electronic commerce transactions that use, a blockchain. The digital wallet is a data structure that can include a private key (e.g., that is only known to the holder of the wallet) and a series of identifiers (sometimes called wallet identifiers, blockchain identifier, or walletlDs herein) that have been generated based on the private key. These identifiers are used to allow other users to “send” transactions, which are recorded on the blockchain, to that identifier. For example, the above novation process creates two blockchain transactions for a trade between Publisher (“Party A”) and the distributed decentralized network administrator (“Party B”). A first blockchain transaction may be from the wallet of party A to the wallet of the Party B. A second blockchain transaction may be from the wallet of the Party B to a wallet of party A. These transactions may be separately generated and submitted to the blockchain. Alternatively, the blockchain may only have one “wallet” that is being used for interacting with the blockchain. Other types of implementations may also be possible (e.g., where different parties, or their respective computer systems, use their own keys for a central blockchain). In certain embodiments, the wallets may be centrally managed by the distributed decentralized network computer system that the parties associated with the trade. However, the transactions recorded to the blockchain may still be signed by or otherwise associated with the individual wallets of the patent stakeholders.

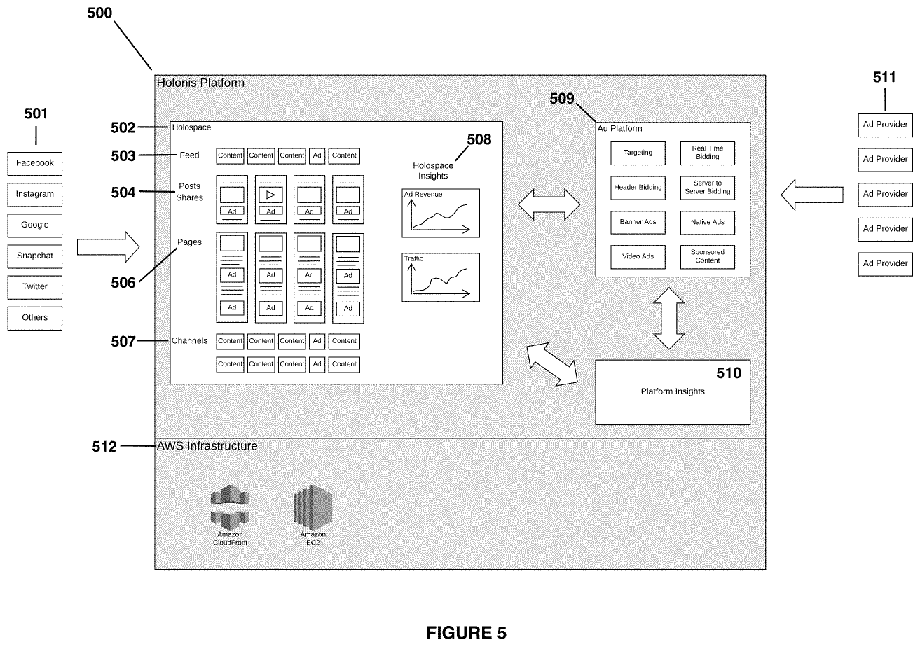

FIG. 5 is a diagram of one embodiment of the advertising monetization system of the present invention. The platform of the present invention 500 creates a link for external social media user accounts 501 to a Holospace user portal 502. The Holospace 502 consists of a content feed 503, shared posts 504, user profile pages 505, and content channels 506. The Holospace 502 also consists of Holospace Insights 508, an analytics engine providing data to advertisers regarding generated ad revenue and user traffic. The Holospace 502 can also provide access to various ad platform options 509, such as: targeting; real-time bidding; header bidding; server to server bidding; banner ads; native ads; video ads; and sponsored content. Both the Holospace 502 and the advertising platform 509 are can access platform insights 510, an additional analytics engine that provides external ad providers 511 with data for the overall Holonis Platform 500. This system is based on the Amazon Web services (“AWS”) infrastructure 512.

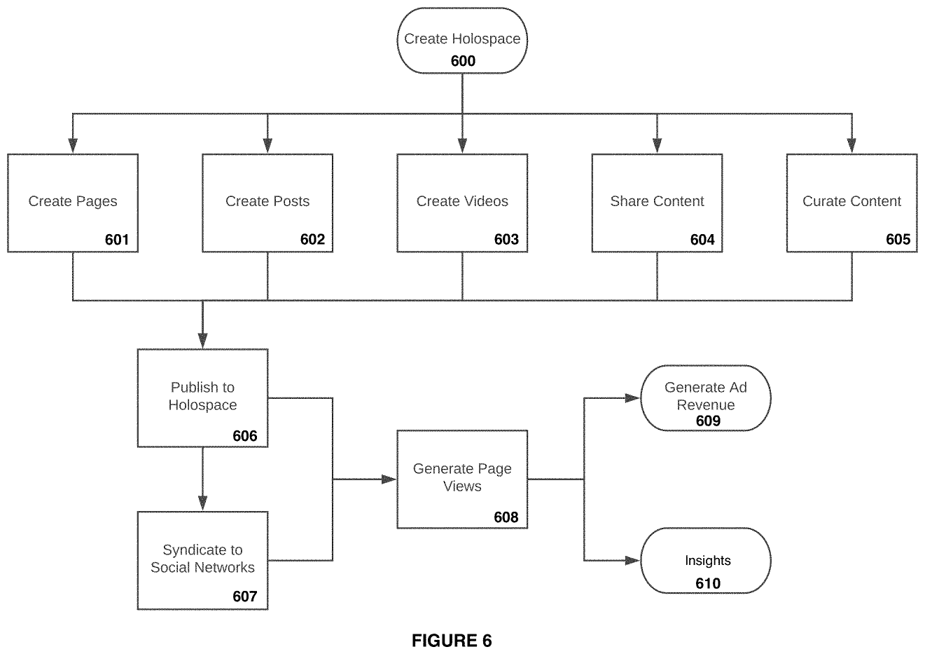

FIG. 6 depicts an embodiment of the overall advertising monetization method of the present invention. The process begins with the creation of a Holospace 600, whereby the user can then create content pages 601, posts 602, and videos 603, as well as share content 604 and curate content 605, all of which is published to the Holospace 606. Once any content is published to the Holospace 606, the user can syndicate content to external social networks 607. Page views can then be generated 608 based on both the content published to the Holospace 606 and syndicated content on external social networks 607. The generated page views 608 provide the data to generate advertising revenue 609 and analytical data through insights 610.

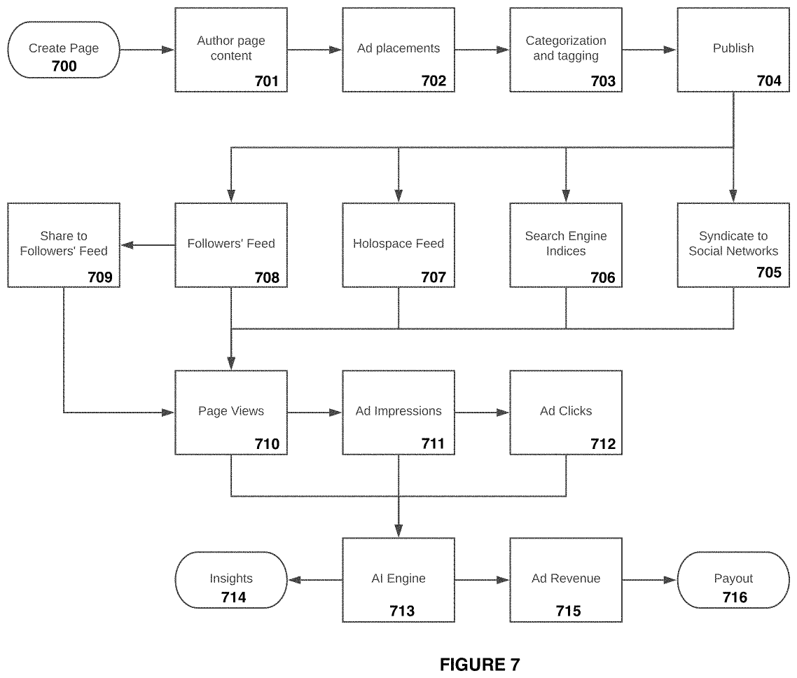

FIG. 7 represents one embodiment of the advertising monetization page creation method of the present invention. Once a page has been created 700, the next step is to provide page content 701, followed by advertisement placement 702. Once the page has been categorized and tagged 703, it can be published 704. The published page 704 can then be syndicated to external social networks 705, published to search engine indices 706, published to the Holospace feed 707, and published to the feeds of followers 708. Through the followers' feed 708, the page can be shared to their respective followers 709 as well. Page views 710 are generated from all streams the page has been published on and syndicated to, which then generates ad impressions 711 and ad clicks 712. The data collected from the page views 710, ad impressions 711, and ad clicks 712 is collected in the Al Engine 713. Through the Al Engine 713, data is analyzed through Insights 714. Based on the collected data, the Al engine 713 also determines the ad revenue 715 and payout 716.

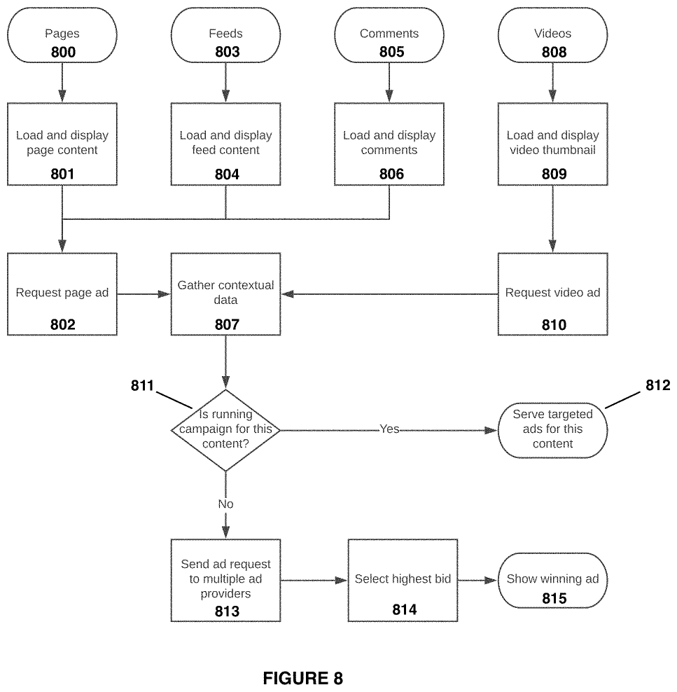

FIG. 8 represents one embodiment of the monetization advertisement placement method of the present invention. Advertisement placement can be determined through various channels, such as: published pages 800 that load and display page content 801; follower feeds 803 that load and display feed content 804; and user comments 805 that are loaded and displayed 806. All content displayed from these channels can be used to request a page advertisement 802. Another content channel is videos 808 that load and display thumbnails 809, in order to request a video advertisement 810. Contextual data is then gathered 807 based on all page 802 and video 810 advertising requests. Advertisements are then selected by determining if the advertiser is running a campaign based on the content 811 from the page or video request data. If it is determined that the advertisement is running a campaign for the content, then targeted ads are served 812. If there are no campaigns related to the content, then ad requests are sent to multiple providers 813, whereby the highest advertising bid is selected 814 and the winning ad is shown 815.

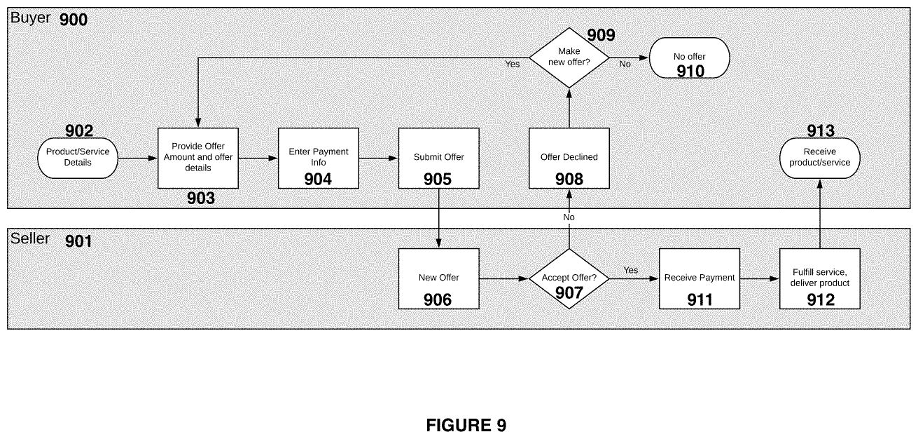

FIG. 9 depicts one aspect of the present embodiment, namely the buyer offer method. A buyer 900 can make an offer when there no minimum offer amount is specified by the seller 901. The buyer 900 can view product or service details 902, and provide an offer amount 903 by entering payment information 904 and submitting the offer 905. The Seller 901 is able to view the new offer 906 and decide whether or not to accept the offer 907. If the seller 901 declines the offer 908, the buyer 900 can then decide to make a new offer 909 or choose not to make a new offer 910. If the seller 901 decides to accept the offer 907, then the seller 901 receives payment 911 and must then fulfill the service or deliver the product 912 to be received by the buyer 913.

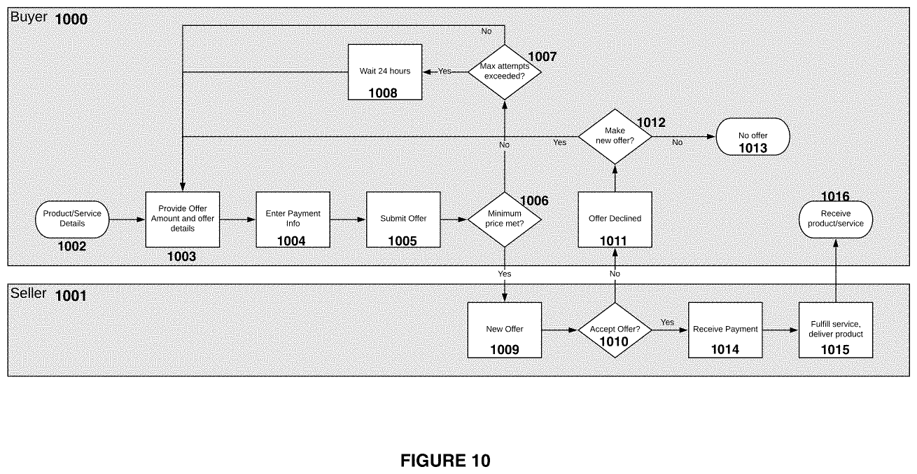

FIG. 10 depicts another embodiment of the buyer offer method of the present invention. A buyer 1000 can make an offer when a minimum offer amount has been specified by the seller 1001. The Buyer 1000 can view product or service details 1002, and provide an offer amount 1003 by entering payment information 1004 and submitting the offer 1005. If the submitted offer 1005 does not meet the minimum amount 1006 threshold and the buyer 1000 has not exceeded the maximum amount of offer attempts 1007, a new offer can be entered 1003. If the maximum amount of offer attempts 1007 has been reached, then the buyer 1000 must wait at least 24 hours 1008 before entering a new offer 1003. If the submitted offer 1005 meets the minimum price 1006 threshold, the Seller 1001 is able to view the new offer 1009 and decide whether or not to accept the offer 1010. If the seller 1001 declines the offer 1011, the buyer 1000 can then has the option to make a new offer 1012 or not make a new offer 1013. If the seller 1001 decides to accept the offer 1010, then the seller 1001 receives payment 1014 and must then fulfill the service or deliver the product 1015 to be received by the buyer 1016.

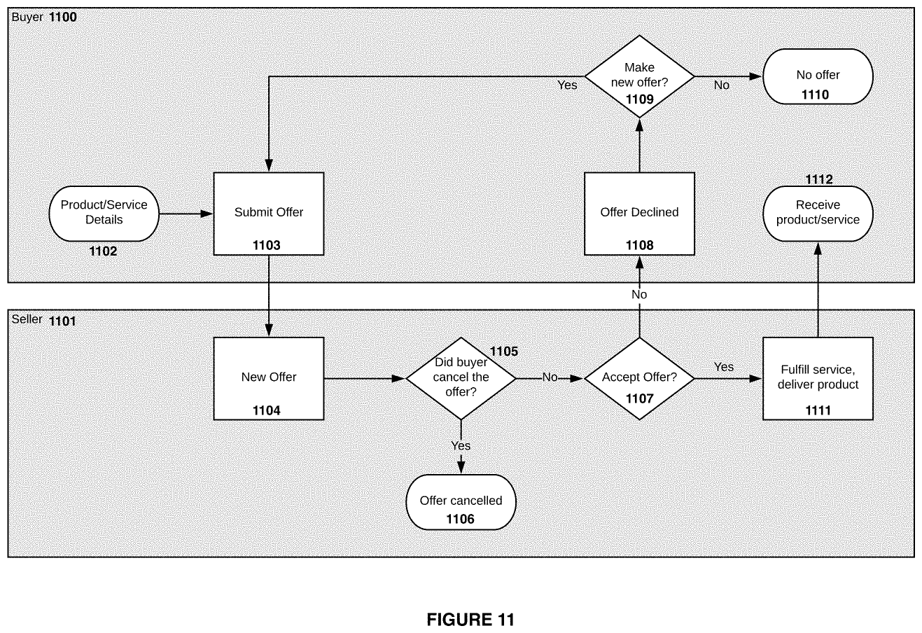

FIG. 11 depicts another aspect of one embodiment of the present invention, the cancellation process. The buyer 1100 can view product or service details 1102 and submit an offer 1103. The seller 1101 is able to view the submitted new offer 1104. If the buyer 1100 cancels the offer 1105, the offer is cancelled 1106 and no longer valid. If the buyer 1100 has not cancelled the offer 1105, the seller 1101 can decided whether or not to accept the offer 1107. If the seller declines the offer 1108, the buyer 1100 can then has the option to make a new offer 1109 or not make a new offer 1110. If the seller 1101 decides to accept the offer 1107, then the seller 1001 must then fulfill the service or deliver the product 1111 to be received by the buyer 1112.

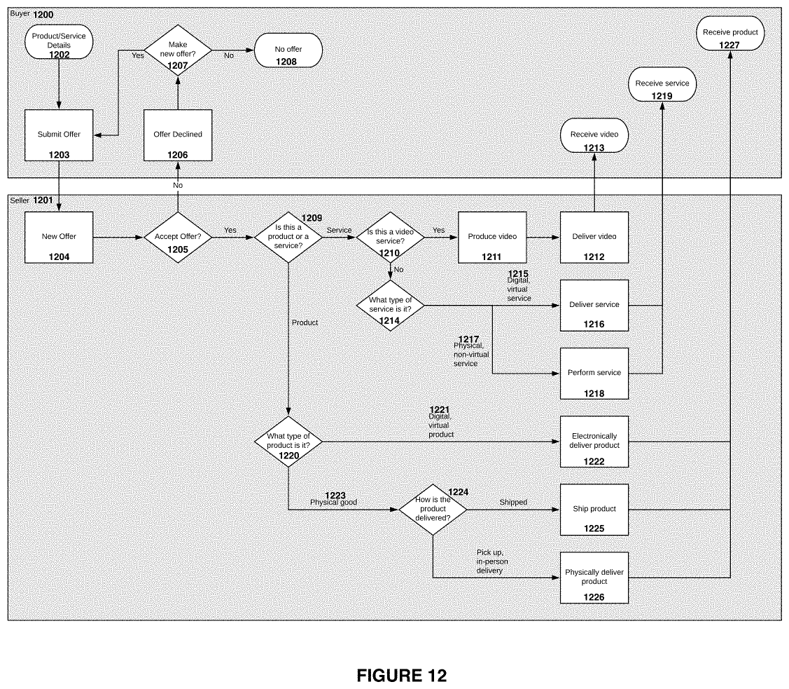

FIG. 12 depicts another aspect of one embodiment of the present invention, the fulfillment process. The buyer 1200 views product or service details 1202 and submits an offer 1203. The seller 1201 receives the new offer 1204 and can decide whether or not to accept the offer 1205. If the seller 1201 declines the offer 1206, the buyer 1200 can then has the option to make a new offer 1207 or not make a new offer 1208. If the seller 1201 accepts the offer 1205, then fulfillment is determined based on if the offer was for a product or a service 1209. If the seller 1201 is providing a service that is a video 1210, the video is then produced 1211 and delivered 1212 to the buyer 1213. If the seller 1201 is providing a service that is not a video, then the type of service is determined 1214 for fulfillment. If the service is digital or virtual 1215, it is provided electronically 1216 to the buyer 1219. If the service is physical and non-virtual 1217, then the seller performs the service 1218 received by the buyer 1219. If the accepted offer is for a product 1220 that is digital or virtual 1221, then the product is electronically delivered 1222 and received by the buyer 1227. If the accepted offer is for a product 1220 that is a physical good 1223, the seller 1201 can choose to ship the product 1225 or physically deliver the product 1226 to be received by the buyer 1227.

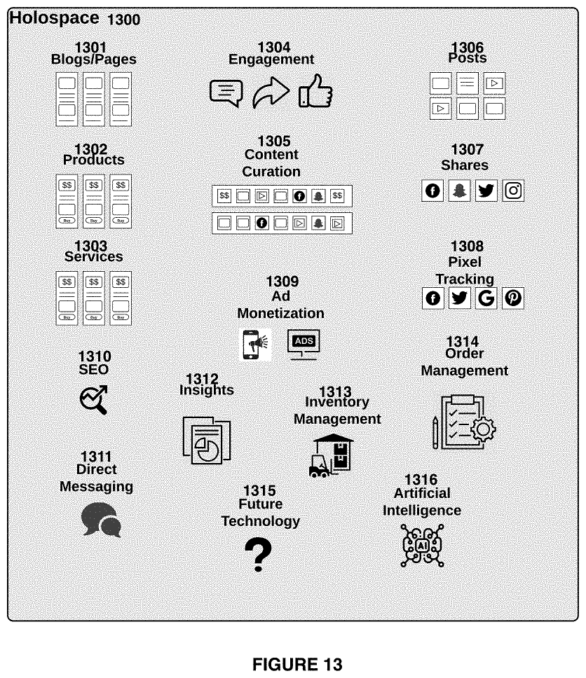

FIG. 13 depicts one embodiment of a potential aspect of the present invention, the combinatorial ecosystem. A Holospace 1300 is comprised of content blogs and pages 1301, products 1302, services 1303, and posts 1306. The Holospace 1300 allows for social networking engagement 1304 and the ability to curate all content 1305, as well as direct messaging 1311 between users. Content can be shared 1307 on external social networks and pixel tracking 1308 can also be utilized. The Holospace 1300 features Search Engine Optimization (“SEO”) 1310, ad monetization 1309 and data analytics through Insights 1312. The Holospace 1300 features e-commerce inventory management 1313 and order management capabilities 1314. The Holospace 1300 is entirely adaptable to future technology 1315 and artificial intelligence 1316 technology.

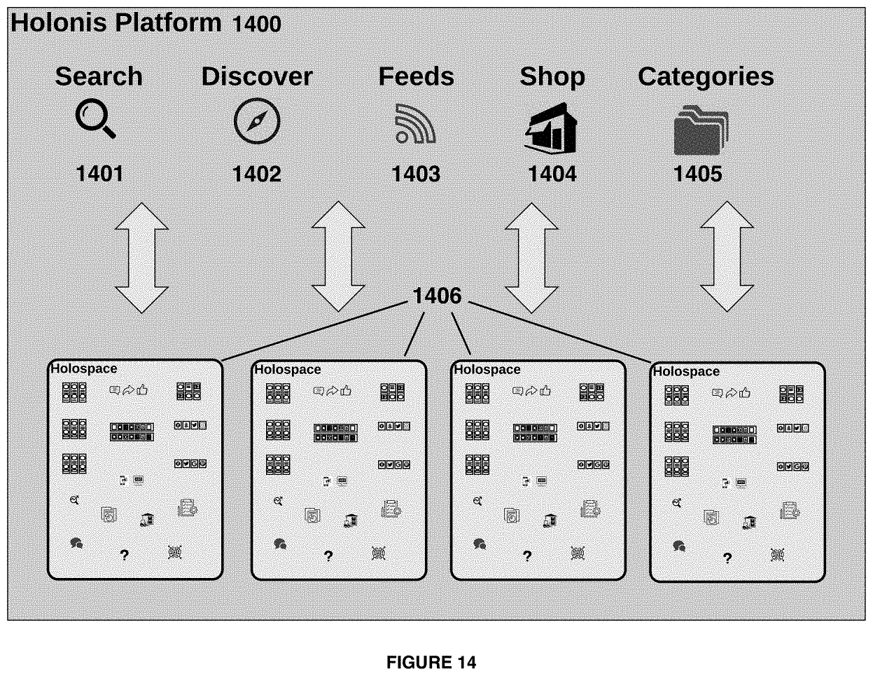

FIG. 14 is another embodiment of the combinatorial ecosystem platform. The Holonis platform 1400 provides a search function 1401, browsing discovery 1402, content feeds 1403, e-commerce shopping 1404, and content file categorization 1405 of various user Holospaces 1406.

The present invention also improves upon an individual user's presence through the use of artificial intelligence. A first neural network coupled to a network server containing a database of each users' individual Holospace inputs data related to each users' online presence and interactions. Through the user of a self-training artificial neural network object or STANNO, imaging cells which allow the STANNO to observe or input data located within the data space utilizing a cell referencing scheme. The artificial neural network which is to be trained is itself part of the STANNO, and at least some of the imaging cells may be representative of the input layer of the artificial neural network. The remaining imaging cells can be used by the STANNO to compare the actual output of the artificial neural network with the desired output associated with each particular input vector.

In general, training an artificial neural network requires a set of training data, including multiple input vectors and associated output vectors, and includes various techniques such as backpropagation, involving repetitive application of input vectors to an input layer of the artificial neural network. With each application of an input vector, the actual output of the artificial neural network, obtained at the output layer, can be evaluated in light of the desired output so that the connection weights and/or biases of the artificial neural network can be adjusted.

As used herein, the term “neural network” is intended to mean an actual or simulated (e.g., by computer program) network comprised of numerous, independent, highly interconnected artificial neurons which simulate the functions of biological neurons. Also, it will be understood that the neural network(s) may have one or more hidden layers.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program or an operating system. The computer program may for instance include one or more of: a subroutine, a function, a procedure, an object method, an object implementation, an executable application, an applet, a servlet, a source code, an object code, a shared library/dynamic load library or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

The present technology requires a data processing system with sufficient memory and processing power to store and recall user data in real time. In addition, the invention may be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups. In particular, the distributed decentralized network discussed herein must be capable of analyzing user and bid data in a manner that can optimize the bidding process.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

In the foregoing specification, the invention has been described with reference to specific examples of embodiments of the invention. It will, however, be evident that various modifications and changes may be made therein without departing from the broader spirit and scope of the invention as set forth in the appended claims.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any reference to “having”, “including” or “comprising” should be applied mutatis mutandis to “consisting” or “consisting essentially of.”

What is claimed is:

1. A system for optimizing an individual's online presence, the system capable of communicating with at least one user's internet connected device, the system comprising:
a processor;
an accessible memory unit capable of storing computer executable instructions, when executed by the processor cause the system to transmit a user interface to the at least one the at least one user device;
the system capable of interacting the at least one social media platform webpage associated with the at least one user;
the user interface capable of displaying information related to activity on the at least one online social media platform webpage associated with the at least at least one user;
the system capable executing actions at least one social media platform webpage associated with at least one user; and
the system further capable of facilitating communication between the at least one user and an online marketplace.

2. The system of claim 1, further configured to conduct actions directed by the at least one user on the at least one social media platform webpage associated with the at least one user.

3. The system of claim 2, configured to reward the at least one user for directing actions to be executed on the at least one social media platform webpage.

4. The system of claim 1, further configured to autonomously execute actions on the at least one social media platform page of the at least one user.

5. The system of claim 4, where the autonomous actions are conducted by a neural network, the neural network trained to execute actions on the at least one social media platform associated with the at least one user that will increase online presence of the number of followers associated with the at least one user.

6. The system of claim 4, where the autonomous actions are conducted by a neural network, the neural network trained to execute actions on the at least one social media platform associated with the at least one user that will increase online presence of the number of followers likes with self-promotion by the at least one user.

7. The system of claim 1, further configured to monetize the at least one user for providing information to at least one advertiser.

8. The system of neural network of claim 6, trained to monetize the at least one user's social media presence.

9. The system of claim 1, configured to connect the at least one user with at least one advertiser.

10. A method improving at least one user's social media influence, the method comprising:
the creation of a profile related to the at least one user;
aggregating third party social media profiles associated with the at least one user into the profile; and
executing instructions that result in the interaction at least one of the aggregated social media profiles associated with the at least one user.

11. The method of claim 10, wherein the user inputs the instructions that result in the interaction with at least one of the aggregated social media profiles associated with the at least one user.

12. The method of claim 10, wherein a self-learning neural network provides the instructions that result in an interaction with at least one of the aggregated social media profiles associated with the at least one user.

13. The method of claim 10, wherein the at least one user is rewarded for providing instructions that result in an interaction with at least one of the aggregated social media profiles associated with the at least one user.

14. The method of claim 10, wherein the profile associated with the at least one user includes access to a customizable brand page.

15. The method of claim 13, wherein the at least one user, can offer services or goods for sale on the custom brand page.

16. A system comprising the deployment of a secure ledger decentralized network, the decentralized network comprising:
at least one hardware processor, a non-transitory machine-readable storage medium having an executable computer readable program code, the at least one hardware processor configured to execute the computer-readable program code to:
receive an executable smart contract;
the smart contract containing at least one term governing the distribution of cryptocurrency in exchange for a social media activity, the amount of virtual currency, the specific social media activity, and the wallet address of the intended recipient of the virtual currency;
receive a request to validate the completion of the at least one term of the smart contract, validate the completion of the at least one term of smart contract;
autonomously conduct the agreed upon activity;
transfer the reward amount to the distribution address; and
update a ledger with the distribution information.

17. The decentralized network of claim 16, wherein the at least one term governing the distribution of a virtual currency is defined by at least one social media subscriber.

18. The decentralized network of claim 16, wherein the at least one term governing a specific social media activity is determined based a request from at least one social media subscriber.

19. The decentralized network of claim 16, wherein the amount of virtual currency to exchange for a specified activity is defined by at least one subscriber.

20. The decentralized network of claim 16, wherein the amount of virtual currency to distribute in exchange for a social media activity autonomously determined by the network.

21. The decentralized network of claim 16, wherein the at least one term governing the distribution of a reward requests the recipient of the reward to engage in a social media activity.

22. The decentralized network of claim 16, wherein the at least one term governing the distribution of a virtual currency is based on an agreement to of at least one subscriber to share personal information to at least one third party.
